(19) United States
(12) Patent Application Publication
(10) Pub. No.: US 2015/0020383 A1
(43) Pub. Date: Jan. 22, 2015

(54) DISASSEMBLY TOOL FOR MEMORY CARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: MEI HUANG, Shenzhen (CN); JIAN-SHE SHEN, Shenzhen (CN); HONG-LIAN HUANG, Shenzhen (CN); JIAN LUO, Shenzhen (CN); WEN-FENG HU, Shenzhen (CN)

(73) Assignees: HON HAI PRECISION INDUSTRY CO., LTD., New Taipei (CN); HONG FU JIN PRECISION INDUSTRY (ShenZhen) CO., LTD., Shenzhen (CN)

(21) Appl. No.: 14/029,738

(22) Filed: Sep. 17, 2013

(30) Foreign Application Priority Data
Jul. 18, 2013 (CN) 2013103022883

(51) Int. Cl. G06F 13/40

(52) U.S. Cl. CPC G06F 13/409
USPC 29/762

(57) ABSTRACT

A disassembly tool for disengaging hooks of a number of memory slots from a number of memory cards includes a base plate, and two pivot arms. The pivot arms are pivotably connected to opposite ends of the base plate. An abutting portion is formed on an end of each pivot arm away from the base plate. When disengaging the hooks, the abutting portions abut the hooks and the base plate is manipulated down, the pivot arms are rotated to make the hooks rotate away from the memory cards.

### BACKGROUND

1. Technical Field

The present disclosure relates to a disassembly tool for memory cards.

2. Description of Related Art

In a computer, a plurality of memory cards is connected to a plurality of memory slots of a motherboard. Two hooks are formed on opposite ends of each memory slot to engage with the corresponding memory card. The hooks need to be manually operated by fingers of a user to pull out the memory card. However, in disassembling the memory cards, the hooks could hurt the user.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of a disassembly tool together with a circuit board.

FIG. 2 is an exploded, isometric view of the disassembly tool of FIG. 1.

FIG. 3 is a front plan view of the disassembly tool and the circuit board of FIG. 1, showing the disassembly tool in a state of use.

FIG. 4 is similar to FIG. 3, but showing a different state.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

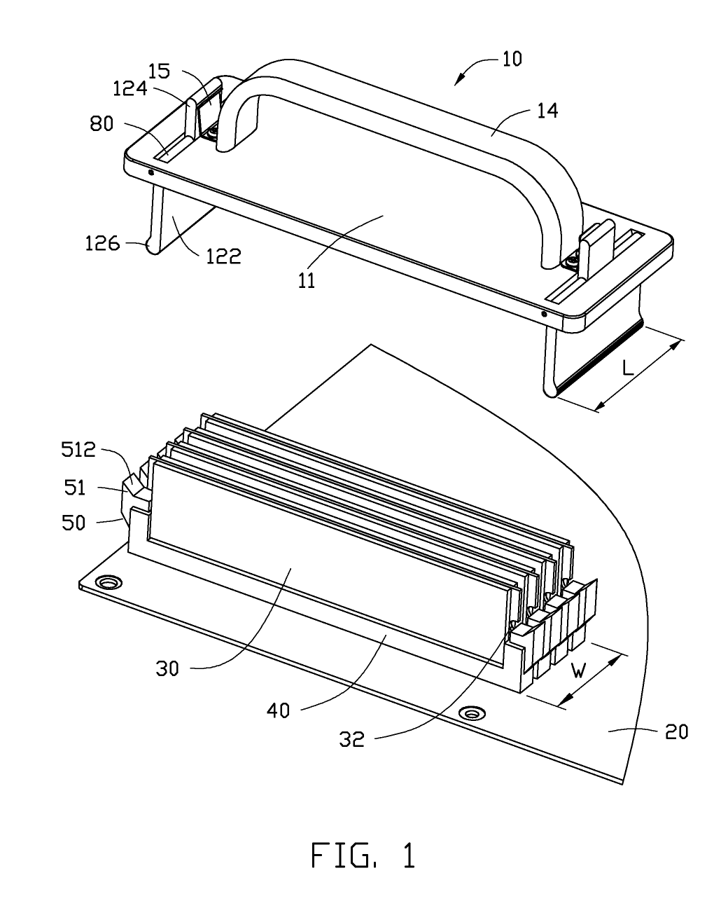

FIG. 1 shows an exemplary embodiment of a disassembly tool 10 for a plurality of memory cards 30. The memory cards 30 are connected to a plurality of memory slots 40 of a circuit board 20.

Two hooking slots 32 are defined in opposite ends of each memory card 30. Two hooks 50 are pivotably connected to opposite ends of each memory slot 40, and engage with the hooking slots 32 of the corresponding memory card 30. A protrusion 51 is formed on a top of each hook 50. The protrusion 51 is spaced from the memory card 30. A slanting surface 512 is formed on an inner side of the protrusion 51 facing the memory card 30.

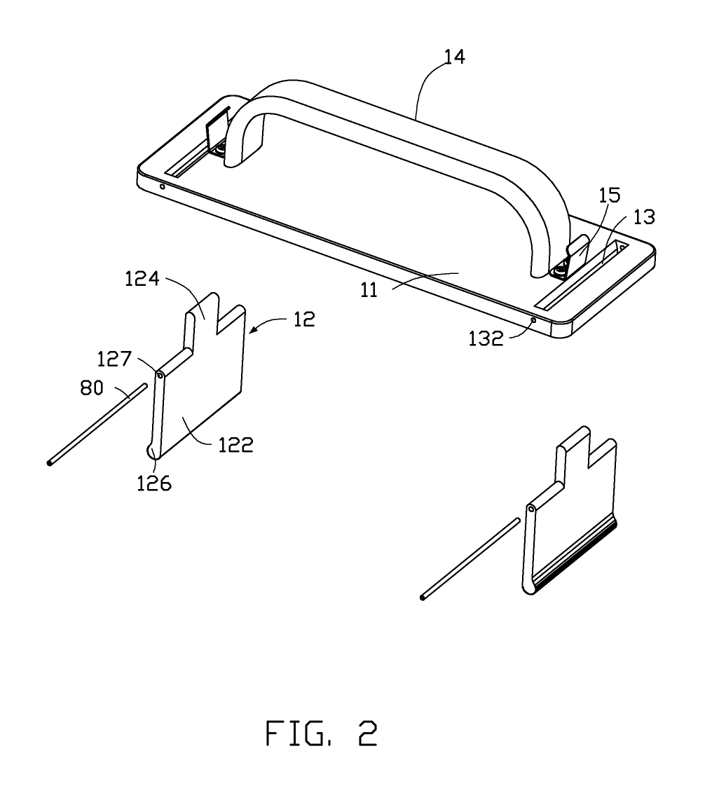

FIG. 2 shows the disassembly tool 10 including a base plate 11 and two pivot arms 12. Two through slots 13 are defined in opposite ends of the base plate 11. A handle 14 extends up from the base plate 11, located between the through slots 13. Two resilient tabs 15 extend up from the base plate 11. Each resilient tab 15 is located between the handle 14 and a corresponding through slot 13. Four through holes 132 are defined in opposite sides of the base plate 11. Two of the through holes 132 communicate with opposite ends of one of the through slots 13, the other two through holes 132 communicate with opposite ends of the other through slot 13. Each pivot arm 12 includes a rectangular main body 122, an extension portion 124 extending from a middle of a first side of the main body 122, and an arced abutting portion 126 formed on a second side of the main body 122 opposite to the first side. The main body 122 defines a through hole 127 adjacent to the extension portion 124 extending along a direction perpendicular to an extension direction of the extension portion 124. The length of the abutting portion 126 is defined as “L”, and the total width of the memory slots 40 is defined as “W”, wherein L>W.

To assemble the disassembly tool 10, the first sides of the pivot arms 12 extend through the through slots 13. Two pins 80 extend through the through holes 132 and the through holes 127, to pivotably connect the pivot arms 12 to the base plate 11. The extension portions 124 abut the resilient tabs 15.

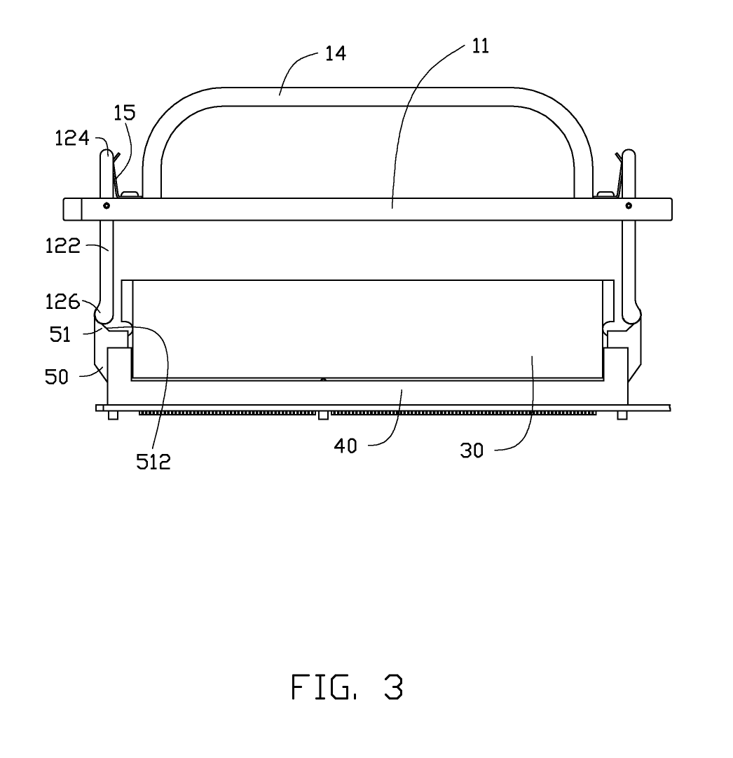

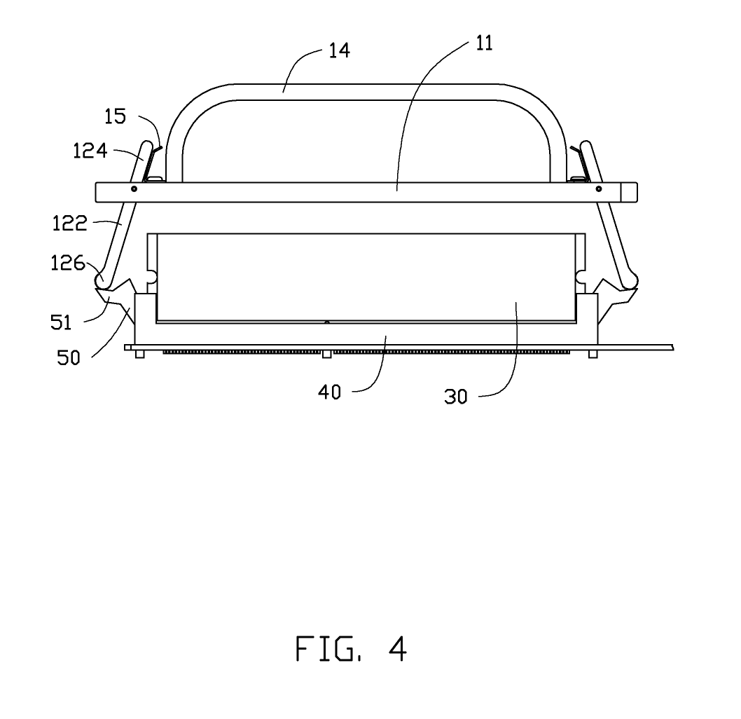

Referring to FIGS. 3 and 4, to pull out the memory cards 30, the abutting portions 126 abut the slanting surfaces 512. The base plate 11 is pushed down. The pivot arms 12 are rotated to allow the abutting portions 126 to move away from the memory cards 30. The hooks 50 are rotate outward by the abutting portions 126 to disengage from the memory cards 30. The resilient tabs 15 are deformed by the extension portions 124.

Therefore, the memory cards 30 can be pulled out from the memory slots 40. After the memory cards 30 are pulled out from the memory slots 40, the resilient tabs 15 bias the pivot arms 12 to rotate back.

The hooks 50 can be disengaged from the memory cards 30 by using the disassembly tool 10, thereby avoiding the hooks 50 from hurting fingers of a user.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A disassembly tool for disengaging hooks of a plurality of memory slots from a plurality of memory cards, comprising:
a base plate; and
two pivot arms pivotably connected to opposite ends of the base plate, each pivot arm forming an abutting portion on a side away from the base plate;
wherein when disengaging the hooks, the abutting portions abut the hooks and the base plate is manipulated down, the pivot arms are rotated to make the hooks rotate away from the memory cards.

2. The disassembly tool of claim 1, wherein a length of each abutting portion is not less than a total width of the plurality of memory slots.

3. The disassembly tool of claim 1, wherein a handle extends up from the base plate, located between the pivot arms.

4. The disassembly tool of claim 1, wherein two resilient tabs extend up from the base plate, adjacent to inner sides of the pivot arms.

5. The disassembly tool of claim 4, wherein each pivot arm comprises a main body and an extension portion extending from the main body, the abutting portion is formed on the main body, the extension portion abuts the corresponding resilient tab.

6. The disassembly tool of claim 1, wherein two through slots are defined in opposite ends of the base plate, the pivot arms extend through the through slots, two pins pivotably extend through the through slots and the pivot arms.

7. The disassembly tool of claim 1, wherein the abutting portions are arced.
